(19) United States
(12) Patent Application Publication
(10) Pub. No.: US 2025/0384722 A1
(43) Pub. Date: Dec. 18, 2025

(54) DATA STORAGE DEVICE, DATA STORAGE METHOD, AND DATA STORAGE PROGRAM

(71) Applicants: TOYOTA JIDOSHA KABUSHIKI KAISHA, Toyota-shi Aichi-ken (JP); DENSO CORPORATION, Kariya-city Aichi-pref (JP)

(72) Inventor: Hiroyuki Mori, Edogawa-ku Tokyo-to (JP)

(73) Assignees: TOYOTA JIDOSHA KABUSHIKI KAISHA, Toyota-shi Aichi-ken (JP); DENSO CORPORATION, Kariya-city Aichi-pref (JP)

(21) Appl. No.: 19/231,681

(22) Filed: Jun. 9, 2025

(30) Foreign Application Priority Data
Jun. 12, 2024 (JP) 2024-095086

(51) Int. Cl. G07C 5/08

(52) U.S. Cl. CPC G07C 5/085; G07C 5/0808

(57) ABSTRACT

A data storage device that stores training data relating to a driving operation of a vehicle in a database, includes a processor configured to: compare manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and determine, based on a comparison result between the manual driving operation data and the comparative driving operation data from the comparison unit, whether to store the manual driving operation data as is as the training data in the database.

### CROSS-REFERENCE TO RELATED APPLICATIONS

This application claims priority to Japanese Patent Application No. 2024-095086 filed Jun. 12, 2024, the entire contents of which are herein incorporated by reference.

### TECHNICAL FIELD

The present disclosure relates to a data storage device, a data storage method, and a data storage program.

### BACKGROUND

It is known that a driving operation performed by a driver is stored in a storage unit (JP 2019-127207 A, JP 2022-129400 A, JP 2023-61084 A). In particular, in JP 2019-127207 A, a technique has been proposed in which a driving operation in a driving situation determined to be inappropriate for training is excluded from a training target in a driving support device configured to learn a driving operation of a driver and thereby reflect driving characteristics of the driver in automated driving of a vehicle.

In JP 2019-127207 A, whether the driving situation is inappropriate for training is determined based on whether various conditions are satisfied, for example, whether the acceleration, deceleration, or yaw rate of the vehicle is a threshold or more. Therefore, all conditions in which the driving situation is appropriate for training need to be set in advance. As explained above, in the device according to JP 2019-127207 A, substantial man-hours are required in order to finely set conditions for determining whether the driving situation is appropriate for training.

In view of the above problem, the present disclosure is intended to eliminate the need to finely set conditions for data storage at the time of storing data for training.

### SUMMARY

The gist of the present disclosure is as follows:

(1) A data storage device configured to store training data relating to a driving operation of a vehicle in a database, the data storage device comprising:
a comparison unit configured to compare manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and
a storage determination unit configured to determine, based on a comparison result between the manual driving operation data and the comparative driving operation data from the comparison unit, whether to store the manual driving operation data as is as the training data in the database.

(2) The data storage device according to above (1), wherein
the training data relating to the driving operation is used to construct a machine learning model through predetermined training, and
autonomous driving by the system of the vehicle is performed by using a model different from the machine learning model constructed through the predetermined learning.

(3) The data storage device according to above (1) or (2), further comprising:
a classification unit configured to classify an environmental condition when the vehicle has traveled; and
a determination unit configured to determine, based on a classification result from the classification unit, whether similar driving operation data obtained when the vehicle is driven in an environmental condition similar to the environmental condition in which the vehicle has traveled is stored in a storage unit,
wherein the comparison unit uses the similar driving operation data as the comparative driving operation data, when the determination unit determines that the similar driving operation data of the similar environmental condition is stored in the storage unit.

(4) The data storage device according to above (3), wherein the classification unit classifies the environmental condition in which the vehicle has traveled, based on at least one of a geographical condition, a temporal condition, a weather condition, or a condition related to a traffic participant in a surrounding area of the vehicle.

(5) The data storage device according to any one of above (1) to (4), wherein in regard to at least a part of the manual driving operation data determined not to be stored as is as the training data in the database, the storage determination unit further determines whether to store the manual driving operation data as the training data in the database after modification of at least a part of the manual driving operation data.

(6) The data storage device according to above (5) or (6), further comprising a data storage unit configured to store data in the database based on a determination by the storage determination unit,
wherein when the storage determination unit determines that the manual driving operation data is stored as the training data after modification of at least a part of the manual driving operation data, the data storage unit modifies at least a part of the manual driving operation data to the corresponding comparative driving operation data and then stores the modified data as the training data in the database.

(7) The data storage device according to above (5) or (6), wherein the storage determination unit determines, for each environmental condition in which the vehicle has traveled, whether to store the manual driving operation data as the training data in the database after modification of at least a part of the manual driving operation data.

(8) The data storage device according to any one of above (1) to (7), further comprising a criterion setting unit configured to set a storage criterion based on a magnitude of an average deviation between the manual driving operation data and the comparative driving operation data for each environmental condition,
wherein the storage determination unit determines, based on the storage criterion corresponding to an environmental condition in which the vehicle has traveled, whether to store the manual driving operation data as is as the training data in the database.

(9) The data storage device according to any one of above (1) to (8), further comprising a driver state determination unit configured to determine, based on an output of a sensor configured to detect a state of a driver,
wherein the storage determination unit determines, based on the state of the driver determined by the driver state determination unit, whether to store the manual driving operation data as is as the training data in the database.

(10) The data storage device according to above (9), further comprising a specifying unit configured to specify, based on a plurality of determination results from the driver state determination unit, a zone in which the state of the driver is likely to be a state unsuitable for driving,
wherein the storage determination unit determines, based on a storage criterion different depending on the zone, whether to store the manual driving operation data as is as the training data in the database.

(11) A data storage method executed by a processor configured to store training data relating to a driving operation of a vehicle in a database, the data storage method comprising:
comparing manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and
determining, based on a comparison result between the manual driving operation data and the comparative driving operation data, whether to store the manual driving operation data as is as the training data in the database.

(12) A data storage program adapted to store training data relating to a driving operation of a vehicle in a database, the data storage program causing a computer to execute:
comparing manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and
determining, based on a comparison result between the manual driving operation data and the comparative driving operation data, whether to store the manual driving operation data as is as the training data in the database.

### BRIEF DESCRIPTION OF DRAWINGS

FIG. 1 is a schematic configuration diagram of a data storage system according to a first embodiment.

FIG. 2 is a schematic configuration diagram of a vehicle.

FIG. 3 is a functional block diagram of a vehicle processor.

FIG. 4 is a schematic configuration diagram of a server.

FIG. 5 is a functional block diagram of a server processor.

FIG. 6 is a diagram illustrating changes in speed of the vehicle when the vehicle travels on a certain road.

FIG. 7 is a flowchart illustrating a flow of data storage processing.

FIG. 8 is a functional block diagram of the server processor according to a second embodiment.

FIG. 9 is a flowchart illustrating a flow of data storage processing according to the second embodiment.

FIG. 10 is a functional block diagram of the server processor according to a third embodiment.

FIG. 11 is a flowchart illustrating a flow of data storage processing according to the third embodiment.

FIG. 12 is a functional block diagram of the server processor according to a modified example of the third embodiment.

### DESCRIPTION OF EMBODIMENTS

Hereinafter, embodiments will be described in detail with reference to the drawings. In the following descriptions, similar components are denoted by the same reference numerals.

### First Embodiment

### Configuration of Data Storage System

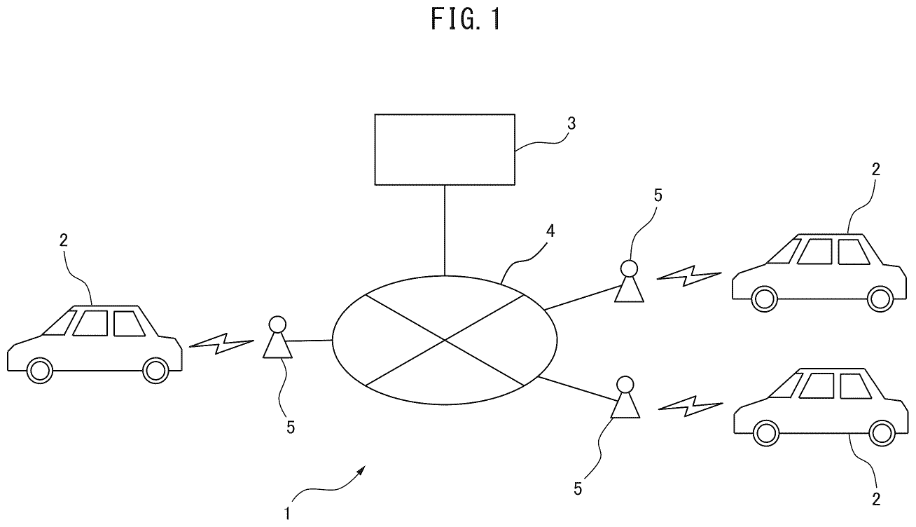

First, a data storage system 1 according to a first embodiment will be described with reference to FIG. 1. FIG. 1 is a schematic configuration diagram of the data storage system 1 according to the first embodiment. The data storage system 1 stores training data relating to a driving operation of a vehicle in a database.

As illustrated in FIG. 1, the data storage system 1 includes a plurality of communicable vehicles 2 and a server 3. Each of the plurality of vehicles 2 and the server 3 are configured so as to be able to communicate with each other via a communication network 4 constituted by an optical communication line or the like and a wireless base station 5 connected to the communication network 4 via a gateway (not illustrated). As the communication between the vehicle 2 and the wireless base station 5, various types of wide-area wireless communication having a long communication distance can be used, and for example, communication conforming to a freely-selected communication standard such as 3GPP, 4G formulated by IEEE, LTE, 5G, and WiMAX is used.

In the data storage system 1 according to the present embodiment, training data is stored in the server 3, based on data received from the plurality of vehicles 2. In the server 3, training of a machine learning model related to autonomous driving of the vehicle 2 is performed based on the stored training data, and the machine learning model for which learning has been completed is transmitted to the vehicle 2. In the vehicle 2, autonomous driving of the vehicle 2 is performed by using the machine learning model transmitted as just described. In the present embodiment, the machine learning model is, for example, a machine learning model obtained by end-to-end learning, and thus when environment data is input, the machine learning model outputs a value of a control parameter for controlling a vehicle actuator 26. However, the machine learning model may be a model trained by using a learning method other than the end-to-end learning.

### Configuration of Vehicle

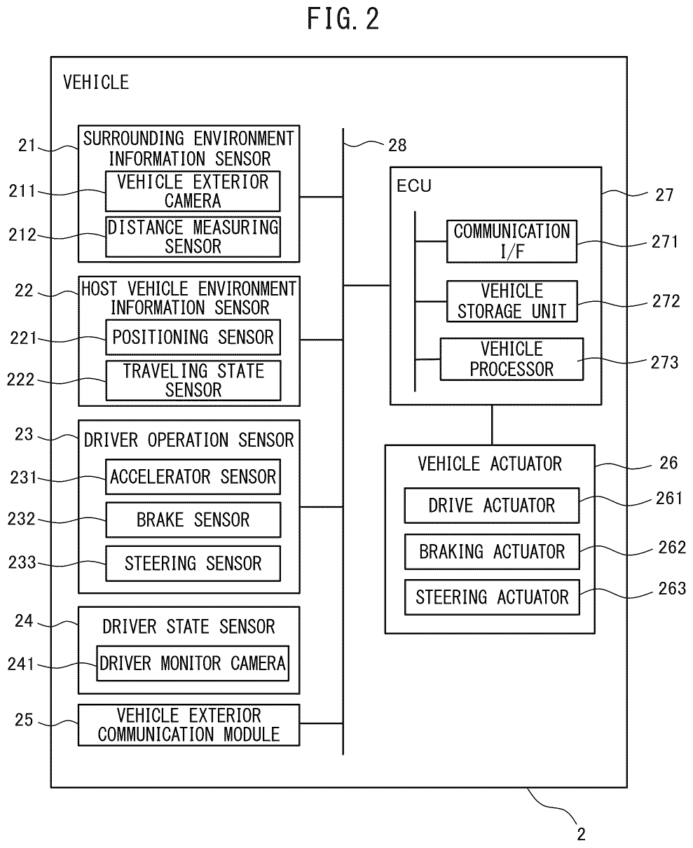

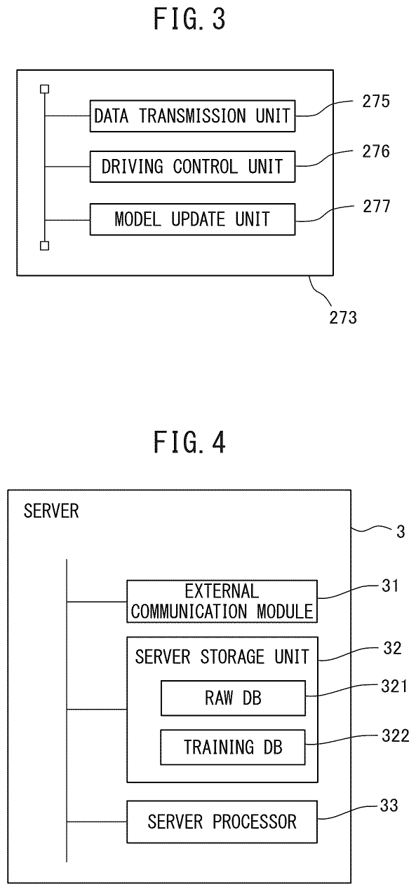

Next, a configuration of the vehicle 2 will be described with reference to FIGS. 2 and 3. The vehicle 2 can be operated and driven manually by a driver, or can be driven autonomously by an ECU of the vehicle 2. The vehicle 2 periodically transmits, to the server 3, manual driving operation data when the vehicle 2 is manually driven by the driver and environment data when the manual driving operation data is obtained. The vehicle 2 performs autonomous driving by using the machine learning model transmitted from the server 3.

FIG. 2 is a schematic configuration diagram of the vehicle 2. In the present embodiment, the vehicle 2 includes a surrounding environment information sensor 21, an host vehicle environment information sensor 22, a driver operation sensor 23, a driver state sensor 24, a vehicle exterior communication module 25, the vehicle actuator 26, and an electronic control unit (hereinafter referred to as “ECU”) 27. These components of the vehicle 2 are communicably connected to each other via an in-vehicle network 28 conforming to a standard such as a Controller Area Network (CAN), or are directly connected to each other via a signal line.

The surrounding environment information sensor 21 is a sensor configured to detect an environment or a situation around the vehicle 2 and generate surrounding environment data that represents the environment or the situation around the vehicle 2. The surrounding environment information sensor 21 includes, for example, a vehicle exterior camera 211 and a distance measuring sensor 212. The vehicle exterior camera 211 captures an image of a surrounding area of the vehicle 2, and in the present embodiment, captures an image of the front of the vehicle 2. The distance measuring sensor 212 measures a distance to an object present in the surrounding area of the vehicle 2, in the present embodiment, a distance to an object present in front of the vehicle 2. The distance measuring sensor 212 is, for example, a radar such as a millimeter-wave radar, a LiDAR, or a sonar.

The host vehicle environment information sensor 22 is a sensor configured to detect a situation of the vehicle 2 and generate vehicle environment data that represents an environment of the vehicle 2 (hereinafter, the surrounding environment data and the vehicle environment data are collectively referred to as environment data). The host vehicle environment information sensor 22 includes, for example, a positioning sensor 221 and a traveling state sensor 222. The positioning sensor 221 measures a self-position of the vehicle 2. The positioning sensor 221 is, for example, a GNSS receiver. The traveling state sensor 222 detects a traveling state of the vehicle 2. The traveling state sensor 222 detects, for example, a speed, an acceleration, a change rate (yaw rate) of a yaw angle at the time of turning, and the like of the vehicle 2.

The driver operation sensor 23 is a sensor configured to detect an operating status of an operation device (for example, an accelerator pedal, a brake pedal, and a steering wheel) of the vehicle 2 by the driver and generate manual driving operation data that represents the operating status of the operation device. The driver operation sensor 23 includes, for example, an accelerator sensor 231 configured to detect a depression amount of the accelerator pedal, a brake sensor 232 configured to detect a depression amount of the brake pedal, and a steering sensor 233 configured to detect a steering angle of the steering wheel.

The manual driving operation data is data that represents the depression amount of the accelerator pedal, the depression amount of the brake pedal, and the steering angle of the steering wheel. Alternatively, the manual driving operation data may be data that represents a situation of the vehicle 2 as a result of the operation of each operation device. Therefore, the manual driving operation data may be data that represents a change in speed or acceleration, a change in turning radius, or the like of the vehicle 2, which is associated with the operation of each operation device. In this case, the manual driving operation data is generated in the ECU 27 based on the operating status of the operation device of the vehicle 2 detected by the driver operation sensor 23.

The driver state sensor 24 is a sensor configured to detect a state of the driver of the vehicle 2 and generate driver state data that represents the state of the driver. The driver state sensor 24 includes, for example, a driver monitor camera 241. The driver monitor camera 241 captures an image of the driver of the vehicle 2.

The surrounding environment information sensor 21, the host vehicle environment information sensor 22, the driver operation sensor 23, and the driver state sensor 24 output the generated information to the ECU 27 via the in-vehicle network 28 at predetermined intervals.

The vehicle exterior communication module 25 communicates with a device outside the vehicle. The vehicle exterior communication module 25 is a device configured to wirelessly communicate with the wireless base station 5 in accordance with a predetermined mobile communication standard. For example, the vehicle exterior communication module 25 receives data generated by the various sensors 21 to 24 of the vehicle 2 from these sensors and transmits the data to the server 3 via the wireless base station 5. Also, the vehicle exterior communication module 25 receives the machine learning model generated or updated by the server 3 via the wireless base station 5 and transmits the machine learning model to the ECU 27.

The vehicle actuator 26 is an actuator used to control driving of the vehicle 2. Specifically, the vehicle actuator 26 includes, for example, a drive actuator 261 configured to control a prime mover (an internal combustion engine or an electric motor) for driving the vehicle 2, a braking actuator 262 configured to control a brake that brakes the vehicle 2, and a steering actuator 263 configured to control steering of the vehicle 2. The vehicle actuator 26 controls driving of the vehicle 2 in accordance with a control signal received from the ECU 27.

The ECU 27 transmits the date generated by the various sensors 21 to 24 of the vehicle 2 to the server 3. In addition, the ECU 27 controls driving of the vehicle 2 by the machine learning model. The ECU 27 includes a communication interface 271, a vehicle storage unit 272, and a vehicle processor 273. The communication interface 271 includes a circuit for connecting the ECU 27 to the in-vehicle network 28 or the like. The vehicle storage unit 272 stores data. The vehicle storage unit 272 includes, for example, at least one of a volatile semiconductor memory, a nonvolatile semiconductor memory, a hard disk drive (HDD), or a solid state drive (SSD). The vehicle storage unit 272 stores a computer program, for example, the machine learning model, executed by the vehicle processor 273. The vehicle processor 273 includes one or a plurality of central processing units (CPUs) and peripheral circuits thereof. The vehicle processor 273 executes the computer program stored in the vehicle storage unit 272.

FIG. 3 is a functional block diagram of the vehicle processor 273. As illustrated in FIG. 3, the vehicle processor 273 includes a data transmission unit 275, a driving control unit 276, and a model update unit 277. These units included in the vehicle processor 273 are, for example, functional modules implemented by the computer program operating on the vehicle processor 273.

The data transmission unit 275 transmits the date generated by the various sensors 21 to 24 of the vehicle 2 to the server 3 via the vehicle exterior communication module 25. The data transmission unit 275 may sequentially transmit the data generated by the various sensors 21 to 24 of the vehicle 2 to the server 3, or may temporarily store the data in the vehicle storage unit 272 and then collectively transmit the data to the server 3. In addition, the data transmission unit 275 may transmit all pieces of data generated by the various sensors 21 to 24 to the server 3, or may transmit a part of the data to the server 3.

The driving control unit 276 controls driving of the vehicle 2. The driving control unit 276 may manually control driving of the vehicle 2 in accordance with an operation of the driver of the vehicle 2, or may autonomously control driving of the vehicle 2 in accordance with the machine learning model. When driving of the vehicle 2 is manually controlled, the driving control unit 276 controls the vehicle actuator 26 based on the manual driving operation data generated by the driver operation sensor 23. In particular, the driving control unit 276 controls the vehicle actuator 26 such that the vehicle 2 is operated in accordance with the operating status of the operating device of the vehicle 2 by the driver. On the other hand, when autonomously controlling driving of the vehicle 2, the driving control unit 276 inputs the environment data generated by the surrounding environment information sensor 21, the host vehicle environment information sensor 22, and the like to the machine learning model, and controls the vehicle actuator 26 in accordance with the output of the machine learning model. Therefore, the driving control unit 276 controls driving of the vehicle 2 not based on the manual driving operation data generated by the driver operation sensor 23 but based on the data generated by the other sensors 21 and 22.

The model update unit 277 updates the machine learning model used for autonomous driving of the vehicle 2 to the model received from the server 3. The model update unit 277 may update a parameter (such as a weight) used for the machine learning model, and may also update a configuration (for example, the number of layers or nodes) of the machine learning model.

### Configuration of Server

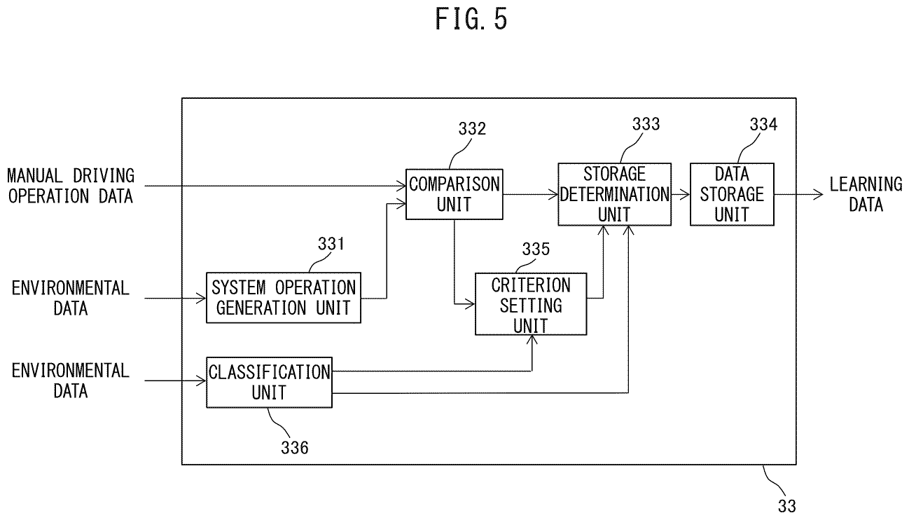

Next, a configuration of the server 3 will be described with reference to FIGS. 4 and 5. The server 3 receives, from the plurality of vehicles 2 communicable via the communication network 4, the manual driving operation data, the environment data, and the driver state data when the vehicles 2 are manually driven. The server 3 stores at least a part of the data received as just described as the training data used for training of the machine learning model. In addition, when a certain amount of training data is stored, the server 3 constructs, based on the stored training data, the machine learning model through predetermined machine learning. The construction of the machine learning model by machine learning may be automatically performed by the server 3, or may be artificially performed by using the training data stored in the server 3. Moreover, when the machine learning model is constructed through machine learning, the server 3 transmits the trained machine learning model to each of the vehicles 2 via the communication network 4.

FIG. 4 is a schematic configuration diagram of the server 3. In the present embodiment, the server 3 includes an external communication module 31, a server storage unit 32, and a server processor 33. The external communication module 31 and the server storage unit 32 are connected to the server processor 33 via a signal line. The server 3 may further include an input device such as a keyboard and a mouse, and an output device such as a display and a speaker. In addition, the server 3 may be constituted by a plurality of computers.

The external communication module 31 communicates with a device outside the server 3. The external communication module 31 includes an interface circuit for connecting the server 3 to the communication network 4. The external communication module 31 is configured to be able to communicate with the vehicle 2 via the communication network 4 and the wireless base station 5.

The server storage unit 32 stores data. The server storage unit 32 includes, for example, an HDD, an SSD, or an optical recording medium. Also, the server storage unit 32 may include a volatile semiconductor memory (for example, RAM), a nonvolatile semiconductor memory (for example, ROM), or the like. The server storage unit 32 stores a computer program executed by the server processor 33. In addition, the server storage unit 32 includes a database in which various pieces of data are stored. In the present embodiment, the server storage unit 32 includes a raw database 321 in which the data received from the vehicle 2 is stored and a training database 322 in which the training data used for training of the machine learning model is stored.

The server processor 33 includes one or a plurality of CPUs and a peripheral circuit thereof. The server processor 33 may further include a logic operation unit, an arithmetic logic unit, or another operation circuit such as a graphics processor unit. The server processor 33 executes various pieces of processing based on the computer program stored in the server storage unit 32. In the present embodiment, the server processor 33 functions as a data storage device configured to store the training data relating to the driving operation of the vehicle 2 in the database. Also, in the present embodiment, the server processor 33 executes a data storage method of storing the training data relating to the driving operation of the vehicle 2 in the database.

FIG. 5 is a functional block diagram of the server processor 33. As illustrated in FIG. 5, the server processor 33 includes a system operation generation unit 331, a comparison unit 332, a storage determination unit 333, a data storage unit 334, a criterion setting unit 335, and a classification unit 336. These units included in the server processor 33 are, for example, functional modules implemented by the computer program operating on the server processor 33. The computer program includes a data storage program adapted to store the training data relating to the driving operation of the vehicle 2 in the database.

The system operation generation unit 331 generates driving operation data (system driving operation data) when it is assumed that the vehicle 2 is autonomously driven by a driving control model in a freely-selected environmental condition. Therefore, when receiving the environment data generated by the vehicle 2 when the vehicle 2 is driven in the freely-selected environment condition, the system operation generation unit 331 outputs the driving operation data when it is assumed that the vehicle 2 is autonomously driven by the driving control model in the environment condition.

The environment data transmitted from the vehicle 2 and stored in the raw database 321 of the server storage unit 32 is input to the system operation generation unit 331. Then, the system operation generation unit 331 outputs, to the comparison unit 332, the system driving operation data when it is assumed that the vehicle 2 is autonomously driven by using the driving control model in the environmental condition corresponding to the input environment data.

In this context, the environmental condition means a condition related to a driving environment of the vehicle 2 when the vehicle 2 is driven. Therefore, the environmental condition includes, for example, a geographical condition related to the road on which the vehicle 2 travels, a temporal condition, a weather condition, and a condition related to traffic participants in the surrounding area of the vehicle 2.

The geographical condition is a condition including the position of the road on which the vehicle 2 travels, landforms (a curvature, a gradient, the number of lanes, and the like of the road), the shape of an object (a building, a tree, or the like) around the road, or the like. The geographical condition is specified based on, for example, the surrounding environment data from the surrounding environment information sensor 21. In addition, the geographical condition is specified based on, for example, self-position data generated by the positioning sensor 221 and map data stored in the server storage unit 32.

The temporal condition is, for example, a condition including a season, a time zone, or the like, and the brightness around the vehicle 2 changes in accordance with the condition. The temporal conditions are specified by information of the time counted by the ECU 27. The weather condition is, for example, a condition including the weather around the vehicle 2, and is classified into sunny, cloudy, rainy, snowy, or the like. The weather condition is specified based on, for example, the surrounding environment data from the surrounding environment information sensor 21. In addition, the weather condition is specified based on the self-position data generated by the positioning sensor 221 and the weather information of each region stored in the server storage unit 32. The traffic participants in the surrounding area of the vehicle 2 mean moving objects that affect the traveling of the vehicle 2, such as other vehicles and pedestrians around the vehicle 2, and the condition related to the traffic participants around the vehicle 2 is a condition including the density and relative positional relationship of such traffic participants. The condition related to the traffic participant in the surrounding area of the vehicle 2 is specified based on, for example, the surrounding environment data from the surrounding environment information sensor 21.

In the present embodiment, the driving control model used by the system operation generation unit 331 is a model different from the machine learning model used for autonomous driving of the vehicle 2. Therefore, hypothetical autonomous driving performed by the system operation generation unit 331 is performed by using a model different from the machine learning model constructed through machine learning with use of the training data. For example, while the machine learning model is a model obtained by end-to-end learning, the driving control model may be a model training using a learning method other than end-to-end learning, or may be a rule-based model generated without being trained using a learning method. In any case, the driving control model is a model that does not necessarily output in the same manner as the machine learning model when there is the same input. As a result, the training data is stored based on the model different from the machine learning model.

The comparison unit 332 compares the manual driving operation data obtained when the vehicle 2 is manually driven in the freely-selected environmental condition with the system driving operation data (comparative driving operation data) generated assuming that the vehicle 2 is autonomously driven by the system (by the driving control model) in the same environmental condition as the freely-selected environmental condition. In particular, in the present embodiment, the degree of deviation between manual driving by the driver and autonomous driving by the system is calculated based on the manual driving operation data and the system driving operation data.

The manual driving operation data transmitted from the vehicle 2 and stored in the raw database 321 of the server storage unit 32 and the system driving operation data to which the environment data corresponding to the manual driving operation data is input in the system operation generation unit 331 and output therefrom are input to the comparison unit 332. Then, the comparison unit 332 outputs the comparison result between the manual driving operation data and the system driving operation data (for example, the degree of deviation) to the storage determination unit 333. In addition, the comparison unit 332 outputs the input manual driving operation data and system driving operation data to the storage determination unit 333 as they arc.

Specifically, the comparison unit 332 calculates, as the degree of deviation, an average value or an integrated value of the difference between a control parameter represented by the manual driving operation data and a control parameter represented by the system driving operation data when the vehicle 2 is located at the same position in the traveling direction of the vehicle 2. For example, an average value or an integrated value of the difference between the depression amount of the accelerator pedal in the manual driving operation data and the depression amount of the accelerator pedal in the system driving operation data is calculated as the degree of deviation. Alternatively, in a case where the driving operation data includes the speed of the vehicle 2, for example, an average value or an integrated value of the difference between the speed of the vehicle 2 in the manual driving operation data and the speed of the vehicle 2 in the system driving operation data is calculated as the degree of deviation. The comparison unit 332 may calculate the degree of deviation by a method different from the method described above as long as the comparison unit 332 can calculate the degree of deviation between manual driving by the driver and autonomous driving by the system. The comparison unit 332 may calculate an index value different from the degree of deviation as long as the index represents the difference between the manual driving operation data and the system driving operation data.

The storage determination unit 333 determines, based on the comparison result between the manual driving operation data and the system driving operation data by the comparison unit 332, whether to store the manual driving operation data as is as the training data in the training database 322 of the server storage unit 32. In the present embodiment, the storage determination unit 333 determines, based on the storage criterion corresponding to the environmental condition (environmental classification classified by the classification unit 336) in which the vehicle 2 has traveled when the manual driving operation data is obtained, whether to store the manual driving operation data as is as the training data in the training database 322. In the present embodiment, the storage criterion is set by the criterion setting unit 335 for each environmental condition (in the present embodiment, for each environmental classification).

For example, the storage determination unit 333 determines, based on the degree of deviation calculated by the comparison unit 332 (i.e., the index that represents the difference between the control parameter represented by the manual driving operation data and the control parameter represented by the system driving operation data), whether to store the manual driving operation data as is as the training data. In particular, in the present embodiment, when the degree of deviation is equal to or less than a storage criterion value corresponding to the environmental condition, the storage determination unit 333 determines to store the manual driving operation data as is as the training data. On the other hand, when the degree of deviation is larger than the storage criterion value corresponding to the environmental condition, the storage determination unit 333 determines not to store the manual driving operation data as is as the training data.

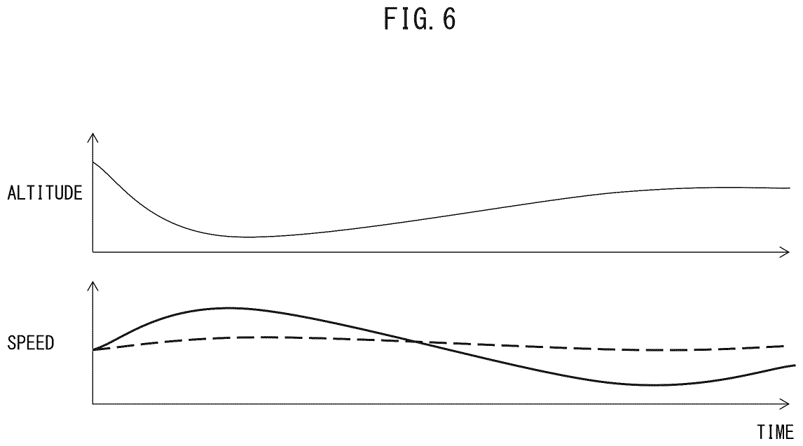

FIG. 6 is a diagram illustrating changes in speed of the vehicle 2 when the vehicle 2 travels on a certain road. In particular, FIG. 6 illustrates changes in altitude of the road on which the vehicle 2 has traveled and changes in speed of the vehicle 2 associated therewith. In the drawing, the solid line related to the speed indicates changes in speed of the vehicle 2 when the vehicle 2 is manually driven by the driver in the environmental condition involving changes in altitude as illustrated in FIG. 6. In addition, the broken line related to the speed indicates changes in speed of the vehicle 2 when the vehicle 2 is autonomously driven by the system in the same environmental condition.

As illustrated in FIG. 6, even when the altitude of the road on which the vehicle 2 travels changes, the driver generally does not change the amount of depression of the accelerator pedal so much. As a result, as indicated by the solid line in FIG. 6, the speed of the vehicle 2 tends to increase when the vehicle 2 travels on a downhill, and the speed of the vehicle 2 tends to decrease when the vehicle 2 travels on an uphill. On the other hand, when the vehicle 2 is autonomously driven by the system, driving of the vehicle 2 is generally controlled such that the speed of the vehicle 2 does not change. Therefore, as indicated by the broken line in FIG. 6, the speed of the vehicle 2 does not change so much even when the vehicle 2 travels on a downhill or an uphill.

As indicated by the solid line in FIG. 6, when the speed of the vehicle 2 changes on an uphill or a downhill, the speeds of other vehicles following the vehicle 2 also change accordingly, which may eventually cause a traffic jam. Therefore, in a case where the speed of the vehicle 2 manually driven by the driver greatly changes when the altitude of the road on which the vehicle 2 travels changes, it is desirable not to use the manual driving operation data generated as a result of such manual driving as the training data. In the present embodiment, in such a case, the degree of deviation between manual driving by the driver and autonomous driving by the system increases, and as a result, the manual driving operation data generated as a result of such sliding driving is not stored as the training data in the training database 322. As a result, storage of inappropriate training data is suppressed. In the present embodiment, whether to store the manual driving operation data as is in the training database 322 is determined based on the degree of deviation automatically calculated by the comparison unit 332. Therefore, in the present embodiment, the training data can be appropriately stored without precisely setting conditions for data storage.

In addition, in regard to at least a part of the manual driving operation data determined not to be stored as is as the training data in the training database 322, the storage determination unit 333 determines whether to store the manual driving operation data as the training data in the training database 322 after modification of at least a part of the manual driving operation data. In the present embodiment, the storage determination unit 333 determines whether to store the manual driving operation data as the training data in the database after modification of a part of the manual driving operation data for each environmental condition when the manual driving operation data is obtained.

For example, the storage determination unit 333 determines whether to store the manual driving operation data as the training data after modification of at least a part of the manual driving operation data based on whether a sufficient amount of training data has already been stored for the environmental condition for which the manual driving operation data has been obtained. Specifically, for example, in a case where the predetermined reference number or more of pieces of training data are stored in the training database 322 for the environment classification when the manual driving operation data is obtained, the storage determination unit 333 determines not to store the manual driving operation data even with performing the modification in the training database 322. On the other hand, for example, when only pieces of training data, which are less than the predetermined reference number of pieces of training data are stored in the training database 322 for the environment classification when the manual driving operation data is obtained, the storage determination unit 333 determines to store the manual driving operation data in the training database 322 after performing the modification.

In this context, there may be an environmental condition in which the degree of deviation between manual driving by the driver and autonomous driving by the system is often large (for example, in the area where a stop sign is provided, at the time of manual driving by the driver, the vehicle is often decelerated but is not completely stopped. In contrast, at the time of autonomous driving by the system, the vehicle is completely stopped). In such an environmental condition, when whether to store data is determined based on the degree of deviation, the training data is not stored at all. On the other hand, in the present embodiment, even when the degree of deviation is large, at least a part of the manual driving operation data is modified and then the training data is stored. Therefore, the training data is prevented from not being stored in some environmental conditions. In the present embodiment, when a sufficient amount of training data has already been stored for each environmental condition, the training data is not stored after at least a part of the manual driving operation data is modified. As a result, the modified data is prevented from being unnecessarily stored.

In regard to all pieces of manual driving operation data determined not to be stored as they are as the training data, the storage determination unit 333 may determine to store the manual driving operation data as the training data after modification of at least a part of each piece of manual driving operation data. Alternatively, the storage determination unit 333 may determine whether to store the manual driving operation data as the training data after modification of at least a part of the manual driving operation data based on the speed at which the manual driving operation data is stored for the environmental classification when the manual driving operation data is obtained. In this case, for the environment classification in which the speed at which the manual driving operation data is stored is low, the storage determination unit 333 determines to store the manual driving operation data as the training data after modification of at least a part of the manual driving operation data.

The comparison result from the comparison unit 332 (degree of deviation), the environment classification classified by the classification unit 336, and the criterion value (deviation criterion) set by the criterion setting unit 335 are input to the storage determination unit 333. In addition, the manual driving operation data and the system driving operation data are input to the storage determination unit 333 from the comparison unit 332. Then, the storage determination unit 333 outputs the determined data storage mode to the data storage unit 334. Also, the storage determination unit 333 outputs the input manual driving operation data and system driving operation data as they are to the data storage unit 334.

The data storage unit 334 stores the data in the training database 322 based on the data storage mode determined by the storage determination unit 333. When the storage determination unit 333 determines that the manual driving operation data is to be stored as is as the training data, the data storage unit 334 stores the manual driving operation data as is as the training data together with the corresponding environment data in the training database 322 of the server storage unit 32. On the other hand, when the storage determination unit 333 determines that the manual driving operation data is stored as the training data after modification of at least a part of the manual driving operation data, the data storage unit 334 modifies at least a part of the manual driving operation data and then stores the modified data as the training data together with the corresponding environment data in the training database 322.

Specifically, in the present embodiment, in the event of modifying at least a part of the manual driving operation data and then storing the modified data as the training data, the data storage unit 334 modifies at least a part of the manual driving operation data to the corresponding system driving operation data and then stores the modified data as the training data in the database. For example, when the degree of deviation from the system driving operation data is large in a specific zone of the manual driving operation data, the data storage unit 334 replaces the manual driving operation data with the system driving operation data for the specific zone and stores the system driving operation data as the training data in the training database 322. Thus, when the degree of deviation is large, relatively appropriate data can be stored as the training data in the training database 322 without performing complicated processing.

Alternatively, the data storage unit 334 may modify at least a part of the manual driving operation data in accordance with a predetermined modification rule. In this case, for example, when the degree of deviation from the system driving operation data is large in a specific region of the manual driving operation data, the data storage unit 334 modifies the manual driving operation data for the specific region in accordance with the predetermined modification rule and stores the modified data as the training data in the database. According to the modification rule, for example, when the speed of the vehicle fluctuates on an uphill, the manual driving operation data is modified so that the speed of the vehicle becomes constant. In addition, according to the modification rule, for example, when there is a stop sign, the manual driving operation data is modified so that the vehicle is once completely stopped. As a result, even when the degree of deviation is large, the data in which at least a part of the manual driving operation data is reflected can be stored in the training database 322.

The data storage mode determined by the storage determination unit 333 is input to the data storage unit 334 from the storage determination unit 333. In addition, the manual driving operation data and the system driving operation data are input to the data storage unit 334 via the comparison unit 332 and the storage determination unit 333. Then, the data storage unit 334 stores the training data in the training database 322.

The criterion setting unit 335 sets the storage criterion (in the present embodiment, the storage criterion value) based on the magnitude of an average deviation between the manual driving operation data and the system driving operation data for each environmental condition (environmental classification). For example, the criterion setting unit 335 sets the storage criterion in a freely-selected environment classification such that the manual driving operation data is more likely to be collected as an average degree of deviation is larger in the environment classification. Specifically, for example, the criterion setting unit 335 increases the storage criterion value in the freely-selected environment classification as the average degree of deviation is larger in the environment classification.

For example, in a congested traffic environmental condition, the steering angle of the steering wheel tends to be relatively large and the degree of deviation tends to be large. In the present embodiment, the storage criterion value related to the steering angle is set to be relatively large in such an environment classification. Therefore, according to the present embodiment, necessary manual driving operation data can be stored even in such environment classification.

Specifically, for each vehicle 2, the manual driving operation data, the system driving operation data, and the environment classification classified by the classification unit 336 are input to the criterion setting unit 335. Then, the criterion setting unit 335 calculates, based on the data input for the large number of vehicles 2, an average value of the degrees of deviation in the large number of vehicles 2 for each environment classification. In addition, the criterion setting unit 335 sets the storage criterion value to be larger stepwise or continuously as the degree of deviation of the environment classification is larger. The criterion setting unit 335 outputs the storage criterion (in the present embodiment, the storage criterion value) set for each environment classification to the storage determination unit 333.

In the present embodiment, the criterion setting unit 335 sets the storage criterion value based on the magnitude of average deviation for each environment classification between the control parameter represented by the manual driving operation data and the control parameter represented by the system driving operation data. However, when an index different from the degree of deviation is used as the index that represents the difference between the control parameters of the manual driving operation data and the system driving operation data, the criterion setting unit 335 sets the storage criterion corresponding to this index. Also in this case, the storage criterion in a freely-selected environment classification is set such that the manual driving operation data is more likely to be collected as the average degree of deviation in the environment classification is larger.

The classification unit 336 classifies the environmental condition at this time into a plurality of environmental classifications based on the environment data when the vehicle 2 has traveled. In particular, the classification unit 336 classifies the environmental condition when the vehicle 2 has traveled into the environmental classification classified based on at least one of the geographical condition, the temporal condition, the weather condition, or the conditions related to traffic participants in the surrounding area of the vehicle. Therefore, for example, the classification unit 336 classifies the environmental condition when the vehicle 2 has traveled into environmental classifications different depending on the landform of the road on which the vehicle 2 travels, or into environmental classifications different depending on the shapes of objects around the road on which the vehicle 2 travels. Thus, the environmental condition when the vehicle 2 has traveled can be appropriately classified for each condition that affects the degree of deviation.

The environment data generated by the vehicle 2 is input to the classification unit 336. The classification unit 336 outputs, based on the input environment data, the classification result (environmental classification) of the environmental condition corresponding to the input environment data to the storage determination unit 333 and the criterion setting unit 335. As a result, the storage determination unit 333 receives the manual driving operation data via the comparison unit 332 and receives the environment classification when the manual driving operation data is obtained.

### Data Storage Processing

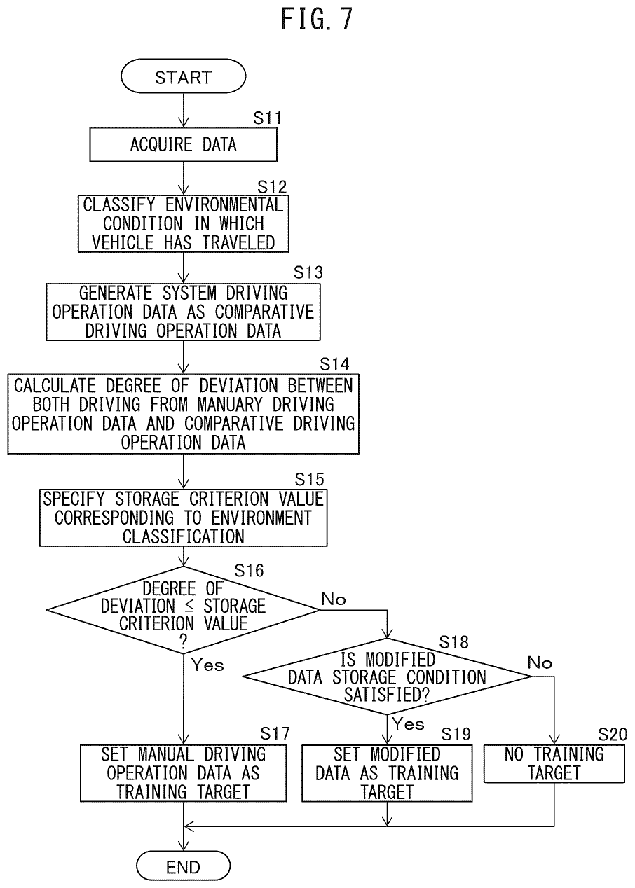

Next, a flow of data storage processing by the data storage system 1 according to the first embodiment will be described with reference to FIG. 7. FIG. 7 is a flowchart illustrating the flow of data storage processing. The data storage processing illustrated in FIG. 7 is performed by the server processor 33.

As illustrated in FIG. 7, in the data storage processing, first, the server processor 33 acquires data from the raw database 321 of the server storage unit 32 (step S11). Specifically, the comparison unit 332 acquires the manual driving operation data, and the system operation generation unit 331 and the classification unit 336 acquire the environment data corresponding to the manual driving operation data (environment data that represents the environmental condition when the manual driving operation data is obtained).

Next, the classification unit 336 classifies, based on the environmental date acquired in step S11, the environmental condition in which the vehicle 2 has traveled into the environmental classification (step S12). Subsequently, the system operation generation unit 331 generates, based on the environment data acquired in step S11, the system driving operation data as the comparative driving operation data to be compared with the manual driving operation data (step S13). Thereafter, the comparison unit 332 calculates the degree of deviation between manual driving by the driver and autonomous driving by the system based on the manual driving operation data acquired in step S11 and the comparative driving operation data generated in step S13 (step S14).

Next, the storage determination unit 333 specifies, based on the environment classification classified by the classification unit 336, the storage criterion value corresponding to the environment classification (step S15). The relationship between the environment classification and the storage criterion value is set by the criterion setting unit 335, and the storage determination unit 333 specifies, based on the environment classification classified by the classification unit 336, the storage criterion value by using the relationship set by the criterion setting unit 335. Then, the storage determination unit 333 determines whether the degree of deviation calculated in step S14 is equal to or less than the storage criterion value specified in step S15 (step S16)

When it is determined in step S16 that the degree of deviation is equal to or less than the storage criterion value, the storage determination unit 333 determines to set the manual driving operation data as a training target, that is, to store the manual driving operation data as the training data in the training database 322 (step S17). As a result, the data storage unit 334 stores the manual driving operation data as the training data in the training database 322. At this time, the data storage unit 334 stores, in addition to the manual driving operation data, the environment data corresponding to the manual driving operation data, as the training data.

On the other hand, when it is determined in step S16 that the degree of deviation is larger than the storage criterion value, the storage determination unit 333 determines whether a modified data storage condition is satisfied (step S18). For example, as described above, the modified data storage condition is a condition which is satisfied when only pieces of training data, which are less than the predetermined reference number of pieces of training data are stored in the training database 322 in the corresponding environment classification. Therefore, the storage determination unit 333 determines, for example, based on the type and volume of the training data stored in the training database 322, whether the modified data storage condition is satisfied.

When it is determined in step S18 that the modified data storage condition is satisfied, the storage determination unit 333 determines to set the modified manual driving operation data as a training target, that is, to store the modified data as the training data in the training database 322 (step S19). As a result, the data storage unit 334 stores the modified data as the training data in the training database 322. At this time, in addition to the modified data, the data storage unit 334 stores the corresponding environment data as the training data. On the other hand, when it is determined in step S18 that the modified data storage condition is not satisfied, the storage determination unit 333 determines not to set both the manual driving operation data and the modified data as training targets, that is, not to store both the manual driving operation data and the modified data as the training data in the training database 322 (step S20).

### Second Embodiment

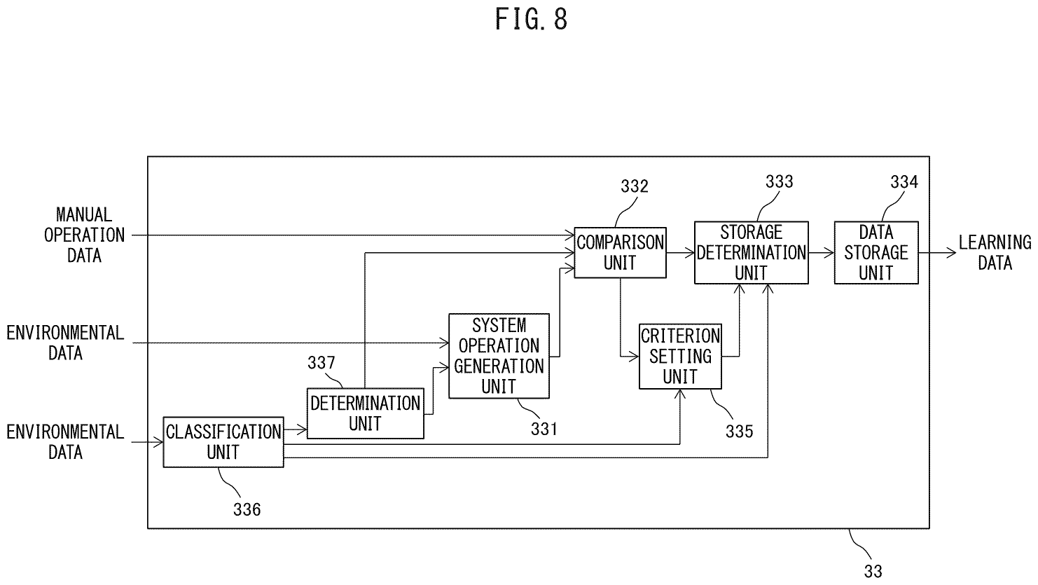

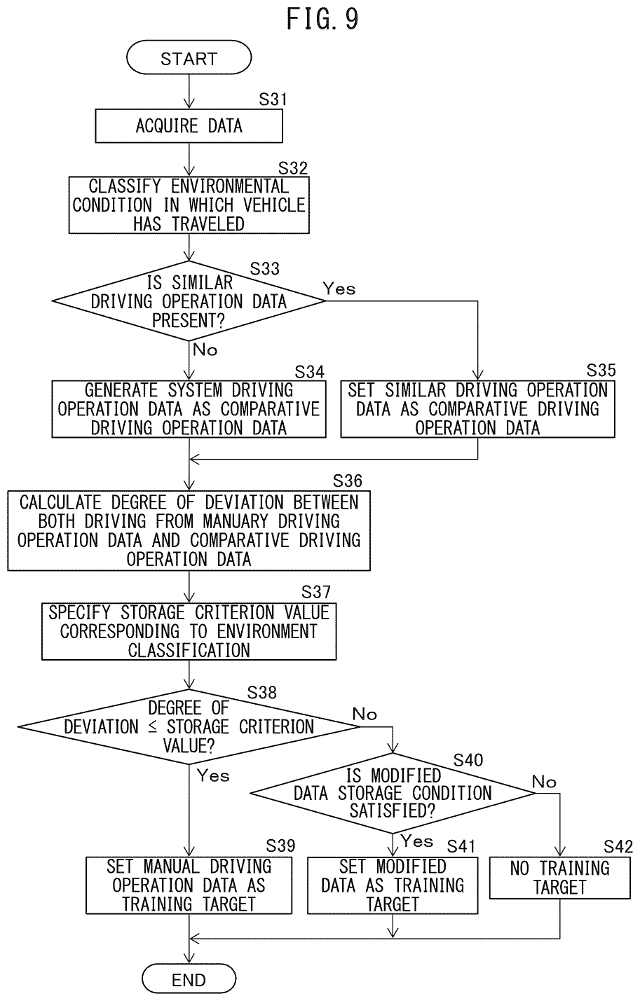

Next, the data storage system 1 according to a second embodiment will be described with reference to FIGS. 8 and 9. The configuration and control of the data storage system 1 according to the second embodiment are basically the same as the configuration and control of the data storage system 1 according to the first embodiment. Hereinafter, portions different from the configuration and control of the data storage system 1 according to the first embodiment will be mainly described.

In the first embodiment, the system driving operation data generated assuming that the vehicle 2 is autonomously driven by the system in the same environmental condition as the environmental condition when the manual driving operation data is obtained is used as the comparative driving operation data to be compared with the manual driving operation data. On the other hand, in the second embodiment, similar driving operation data when the vehicle 2 is driven in an environmental condition similar to the environmental condition when the manual driving operation data is obtained is also used as the comparative driving operation data.

FIG. 8 is a functional block diagram of the server processor 33 according to the second embodiment. As illustrated in FIG. 8, the server processor 33 of the present embodiment includes a determination unit 337 in addition to the units included in the server processor 33 according to the first embodiment.

The determination unit 337 determines, based on the classification result from the classification unit 336, whether the similar driving operation data when the vehicle 2 is driven in the environmental condition similar to the environmental condition in which the vehicle 2 has traveled is present in the server storage unit 32. In the present embodiment, the similar driving operation data is past manual driving operation data obtained when manual driving is performed by the driver of the vehicle 2 or a driver different from the driver of the vehicle 2 in each environment classification. In particular, in the present embodiment, the similar driving operation data is past manual driving operation data obtained when manual driving is performed by a superior driver in each environment classification. Therefore, the determination unit 337 determines whether there is past manual driving operation data obtained when manual driving is performed by a superior driver in the environment classification classified by the classification unit 336.

In the present embodiment, the past manual driving operation data obtained when manual driving is performed by the superior driver is stored in the server storage unit 32 together with the classification of environmental conditions (environmental classification) when the manual driving operation data is obtained. Thus, the variety of environment classifications and the past manual driving operation data by the superior driver corresponding to the environment classifications are stored in the server storage unit 32. However, the past manual driving operation data by the superior driver corresponding to all of the environment classifications are not always stored in the server storage unit 32.

The environment classification classified by the classification unit 336 is input to the determination unit 337. The determination unit 337 determines, based on the environment classification classified by the classification unit 336, whether the past manual driving operation data by the superior driver corresponding to the environment classification is stored in the server storage unit 32. In addition, when determining that the past manual driving operation data by the superior driver corresponding to the environment classification is stored in the server storage unit 32, the determination unit 337 outputs the past manual driving operation data as the similar driving operation data to the comparison unit 332. On the other hand, when determining that the past manual driving operation data by the superior driver corresponding to the environment classification is not stored in the server storage unit 32, the determination unit 337 outputs a signal indicating that the past manual driving operation data is not stored, that is, the similar driving operation data is not stored, to the system operation generation unit 331.

When the determination unit 337 determines that the similar driving operation data is stored in the server storage unit 32, that is, when the similar driving operation data is input from the determination unit 337, the comparison unit 332 uses the similar driving operation data as the comparative driving operation data. Therefore, in this case, the comparison unit 332 compares the manual driving operation data obtained when the vehicle 2 is manually driven in a freely-selected environmental condition (a freely-selected environmental classification) with the similar driving operation data obtained when the vehicle 2 is driven in an environmental condition similar to the environmental condition (the same environmental classification). Then, the comparison unit 332 outputs the comparison result (for example, the degree of deviation) between the manual driving operation data and the similar driving operation data to the storage determination unit 333. The comparison between the manual driving operation data and the similar driving operation data is performed in the same manner as the comparison between the manual driving operation data and the system driving operation data.

On the other hand, when the determination unit 337 determines that the similar driving operation data is not stored in the server storage unit 32, that is, when the signal indicating that the similar driving operation data is not stored is input from the determination unit 337, the system operation generation unit 331 generates system driving operation data. Then, the system operation generation unit 331 inputs the generated system driving operation data to the comparison unit 332. In this case, the comparison unit 332 compares the manual driving operation data with the system driving operation data. Therefore, in the present embodiment, the comparison unit 332 compares the manual driving operation data with the similar driving operation data and the system driving operation.

As described above, in the present embodiment, when the similar driving operation data is stored in the server storage unit 32, the similar driving operation data is used. As a result, for example, the degree of deviation is calculated based on comparison with the driving operation data obtained when manually driving is performed by the superior driver. Thus, the data to be stored as the training data in the training database 322 can be more appropriately determined.

The data storage system 1 according to the first embodiment and the data storage system 1 according to the second embodiment may be used in combination. In this case, the data storage system 1 according to the first embodiment and the data storage system 1 according to the second embodiment may be selectively used depending on conditions. For example, when the manual driving operation data is data at the time of traveling on a limited highway, the system driving operation data may be used as the comparative driving operation data. When the manual driving operation data is data at the time of traveling on a general road, the similar driving operation data may be used as the comparative driving operation data. Thus, when autonomous driving by the system is possible only on a limited highway, the data to be stored as the training data in the training database 322 can be appropriately determined on both a limited highway and a general road.

Next, a flow of data storage processing by the data storage system 1 according to the second embodiment will be described with reference to FIG. 9. FIG. 9 is a flowchart illustrating the flow of data storage processing according to the second embodiment. The data storage processing illustrated in FIG. 9 is performed by the server processor 33. Note that, steps S31, S32, S34, and S36 to S42 in FIG. 9 are the same as steps S11 to S20 in FIG. 7, respectively, and thus the description thereof is omitted.

As illustrated in FIG. 9, when the classification unit 336 performs classification in step S32, the determination unit 337 determines whether the similar driving operation data is stored in the server storage unit 32 in the environment classification classified by the classification unit 336 (step S33). When it is determined in step S33 that the similar driving operation data is not stored in the server storage unit 32, the system operation generation unit 331 generates system driving operation data as the comparative driving operation data (step S34). On the other hand, when it is determined in step S33 that the similar driving operation data is stored in the server storage unit 32, the determination unit 337 sets the similar driving operation data as the comparative driving operation data to be compared with the manual driving operation data (step S35).

### Third Embodiment

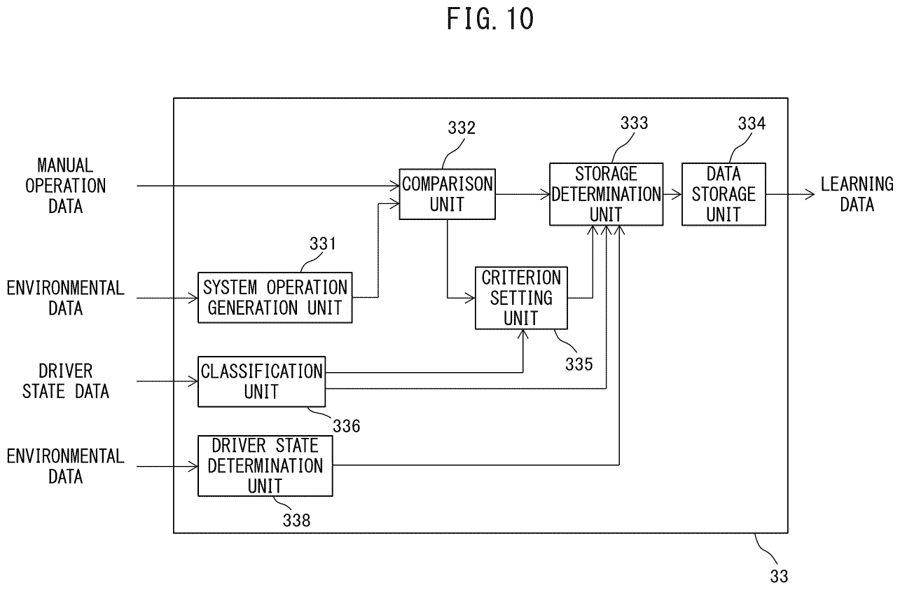

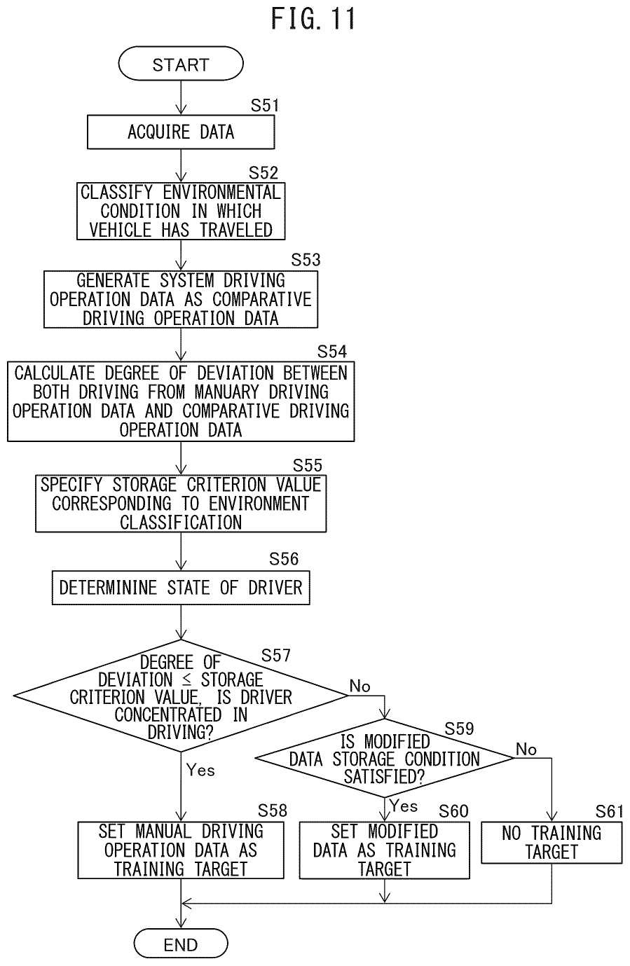

Next, the data storage system 1 according to a third embodiment will be described with reference to FIGS. 10 and 11. The configuration and control of the data storage system 1 according to the third embodiment are basically the same as the configuration and control of the data storage system 1 according to the first embodiment. Hereinafter, portions different from the configuration and control of the data storage system 1 according to the first embodiment will be mainly described. Although a part of the control of the data storage system 1 according to the first embodiment is changed in the third embodiment, a part of the control of the data storage system 1 according to the second embodiment may be changed.

In the data storage system 1 according to the first embodiment, the driver state data that represents the state of the driver is not used to determine whether to store the manual driving operation data as is. On the other hand, in the data storage system 1 according to the third embodiment, in addition to the degree of deviation between the manual driving operation data and the comparative driving operation data, the driver state data that represents the state of the driver is used to determine whether to store the manual driving operation data as is.

FIG. 10 is a functional block diagram of the server processor 33 according to the third embodiment. As illustrated in FIG. 10, the server processor 33 of the present embodiment includes a driver state determination unit 338 in addition to the units included in the server processor 33 according to the first embodiment.

The driver state determination unit 338 determines the state of the driver based on an output of the driver state sensor 24 that detects the state of the driver. In the present embodiment, for example, the driver state determination unit 338 sequentially inputs image data of images captured by the driver monitor camera 241 to a discriminator and thereby detects the state of the driver represented by each piece of image data. In particular, in the present embodiment, the driver state determination unit 338 determines whether the state of the driver is a concentrated driving state in which the driver is concentrated in driving or a distracted driving state in which the driver is not concentrated in driving. For example, when the driver is not looking at the road during driving, when the driver is closing his/her eyes, when the driver is losing his/her posture, when the driver's hand is away from the steering wheel, or the like, the driver's driving is determined as distracted driving. The discriminator is, for example, a convolutional neural network (CNN) having a plurality of convolutional layers connected in series from the input side to the output side. Although the driver monitor camera 241 is used as the driver state sensor 24 in the present embodiment, another sensor such as a grip sensor configured to detect whether the driver is gripping the steering wheel may be used.

In addition, in the present embodiment, the storage determination unit 333 determines, based on, in addition to the comparison result from the comparison unit 332, the state of the driver determined by the driver state determination unit 338, whether to store the manual driving operation data as is as the training data in the training database 322. Specifically, for example, when the driver state determination unit 338 determines that the driving state of the driver is a distracted driving state, the storage determination unit 333 determines not to store the manual driving operation data as is as the training data in the training database 322 regardless of the comparison result from the comparison unit 332. On the other hand, for example, when the driver state determination unit 338 determines that the driving state of the driver is a concentrated driving state, the storage determination unit 333 determines, based on the comparison result from the comparison unit 332, whether to store the manual driving operation data as is as the training data in the training database 322.

According to the present embodiment, whether to store the manual driving operation data as the training data is determined based on, in addition to the comparison result from the comparison unit 332, the state of the driver determined by the driver state determination unit 338. As a result, the manual driving operation data when the driving state of the driver is inappropriate (for example, when the driving state of the driver is a distracted driving state) is prevented from being stored as the training data, and thus appropriate training data can be stored in the training database 322.

At least one of the data storage system 1 according to the first embodiment or the data storage system 1 according to the second embodiment may be used in combination with the data storage system 1 according to the third embodiment. In this case, the data storage system 1 according to the first embodiment, the data storage system 1 according to the second embodiment, and the data storage system 1 according to the third embodiment may be selectively used depending on conditions.

Next, a flow of data storage processing by the data storage system 1 according to the third embodiment will be described with reference to FIG. 11. FIG. 11 is a flowchart illustrating the flow of data storage processing according to the third embodiment. The data storage processing illustrated in FIG. 11 is performed by the server processor 33. Note that, steps S51 to S55 and steps S58 to S61 in FIG. 11 are the same as steps S11 to S15 and steps S17 to S20 in FIG. 7, respectively, and thus the description thereof is omitted.

As illustrated in FIG. 11, when the storage criterion value corresponding to the environment classification is specified in step S55, the driver state determination unit 338 determines the state of the driver based on an output of the driver state sensor 24 (step S56). Next, the storage determination unit 333 determines whether the degree of deviation calculated in step S54 is equal to or less than the storage criterion value and whether the state of the driver is a concentrated driving state (step S57).

When it is determined in step S57 that the degree of deviation is equal to or less than the storage criterion value and that the state of the driver is a concentrated driving state, the storage determination unit 333 determines to set the manual driving operation data as a training target (step S58). On the other hand, when it is determined in step S57 that the degree of deviation is larger than the storage criterion value or when it is determined that the state of the driver is a distracted driving state, the storage determination unit 333 determines whether the modified data storage condition is satisfied (step S59).

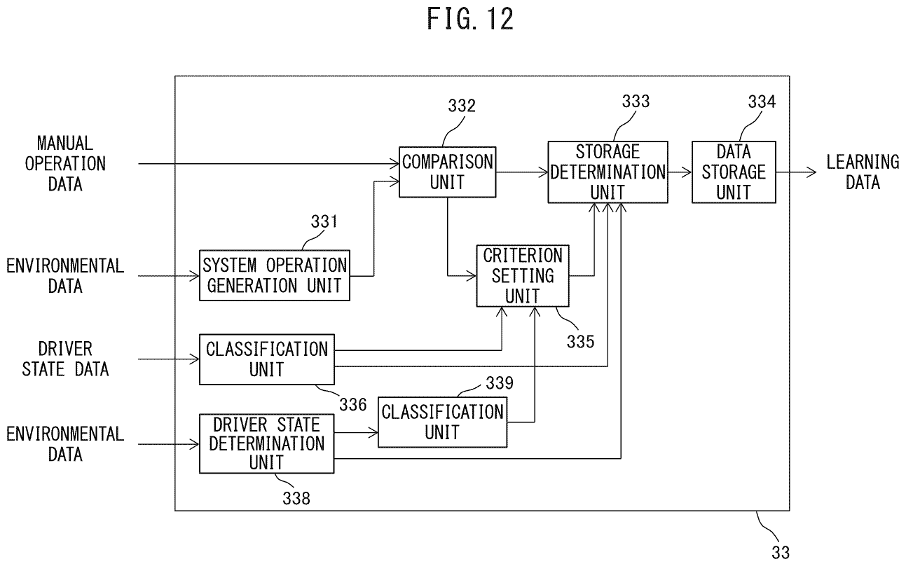

As illustrated in FIG. 12, the server processor 33 may include a specifying unit 339 configured to specify, based on a plurality of determination results from the driver state determination unit 338, a zone on the road where the state of the driver is likely to be a state unsuitable for driving (for example, a distracted driving state). The determination results of the driver state determination unit 338 for a variety of driving operations are input to the specifying unit 339, and the environment data corresponding to the driving operation at this time (in particular, the data of the zone in which the vehicle 2 has traveled) is input to the specifying unit 339. The specifying unit 339 specifies, based on such input data, a zone in which the driver is likely to be in a distracted driving state (hereinafter, also referred to as a “distracted driving zone”). The specifying unit 339 outputs information of the distracted driving zone to the criterion setting unit 335.

The criterion setting unit 335 sets, in addition to the environment classification, the storage criterion based on the distracted driving zone. In particular, the criterion setting unit 335 sets the storage criterion such that the manual driving operation data is unlikely to gather in the distracted driving zone. Therefore, the criterion setting unit 335 sets the storage criterion value to be small for the distracted driving zone. As a result, the storage determination unit 333 determines, based on the storage criterion different depending on each zone on the road, whether to store the manual driving operation data as is as the training data in the training database 322. As a result, the manual driving operation data when the driving state of the driver is inappropriate (for example, when the driving state of the driver is a distracted driving state) is prevented from being stored as the training data, and thus appropriate training data can be stored in the training database 322.

Although the embodiments according to the present disclosure have been described above, the present disclosure is not limited to these embodiments, and various modifications and changes can be made within the scope of the claims.

While embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A data storage device configured to store training data relating to a driving operation of a vehicle in a database, the data storage device comprising a processor, the processor is configured to:
compare manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and
determine, based on a comparison result between the manual driving operation data and the comparative driving operation data, whether to store the manual driving operation data as is as the training data in the database.

2. The data storage device according to claim 1, wherein
the training data relating to the driving operation is used to construct a machine learning model through predetermined training, and
autonomous driving by the system of the vehicle is performed by using a model different from the machine learning model constructed through the predetermined learning.

3. The data storage device according to claim 1, wherein,
the processor is further configured to:
classify an environmental condition when the vehicle has traveled; and
determine, based on a classification result, whether similar driving operation data obtained when the vehicle is driven in an environmental condition similar to the environmental condition in which the vehicle has traveled is stored in a storage unit, and
the processor is configured to use the similar driving operation data as the comparative driving operation data, when it is determined that the similar driving operation data of the similar environmental condition is stored in the storage unit.

4. The data storage device according to claim 3, wherein the processor is configured to classify the environmental condition in which the vehicle has traveled, based on at least one of a geographical condition, a temporal condition, a weather condition, or a condition related to a traffic participant in a surrounding area of the vehicle.

5. The data storage device according to claim 1, wherein in regard to at least a part of the manual driving operation data determined not to be stored as is as the training data in the database, the processor is configured to further determine whether to store the manual driving operation data as the training data in the database after modification of at least a part of the manual driving operation data.

6. The data storage device according to claim 5, wherein
the processor is further configured to:
store data in the database based on a determination by the processor, and
when it is determined that the manual driving operation data is stored as the training data after modification of at least a part of the manual driving operation data, modify at least a part of the manual driving operation data to the corresponding comparative driving operation data and then store the modified data as the training data in the database.

7. The data storage device according to claim 5, wherein the processor is configured to determine, for each environmental condition in which the vehicle has traveled, whether to store the manual driving operation data as the training data in the database after modification of at least a part of the manual driving operation data.

8. The data storage device according to claim 1, wherein the processor is configured to:
set a storage criterion based on a magnitude of an average deviation between the manual driving operation data and the comparative driving operation data for each environmental condition, and
determine, based on the storage criterion corresponding to an environmental condition in which the vehicle has traveled, whether to store the manual driving operation data as is as the training data in the database.

9. The data storage device according to claim 1, wherein the processor is configured to:
determine, based on an output of a sensor configured to detect a state of a driver, and
determine, based on the state of the driver, whether to store the manual driving operation data as is as the training data in the database.

10. The data storage device according to claim 9, wherein the processor is configured to:
specify, based on a plurality of determination results, a zone in which the state of the driver is likely to be a state unsuitable for driving, and
determine, based on a storage criterion different depending on the zone, whether to store the manual driving operation data as is as the training data in the database.

11. A data storage method executed by a processor configured to store training data relating to a driving operation of a vehicle in a database, the data storage method comprising:
comparing manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and
determining, based on a comparison result between the manual driving operation data and the comparative driving operation data, whether to store the manual driving operation data as is as the training data in the database.

12. A non-transitory recording medium having recorded thereon a data storage program adapted to store training data relating to a driving operation of a vehicle in a database, the data storage program causing a computer to execute:
comparing manual driving operation data obtained when the vehicle is manually driven in a predetermined environmental condition with comparative driving operation data including at least one of system driving operation data generated assuming that the vehicle is autonomously driven by a system of the vehicle in the same environmental condition as the predetermined environmental condition or similar driving operation data when the vehicle is driven in an environmental condition similar to the predetermined environmental condition; and
determining, based on a comparison result between the manual driving operation data and the comparative driving operation data, whether to store the manual driving operation data as is as the training data in the database.
